(19) United States
(12) Patent Application Publication
(10) Pub. No.: US 2008/0142669 A1
(43) Pub. Date: Jun. 19, 2008

(54) System for Displaying Photographs

(76) Inventor: Peter S. Zlotocha, Hartland, WI (US)

Correspondence Address: REINHART BOERNER VAN DEUREN P.C., 2215 PERRYGREEN WAY, ROCKFORD, IL, 61107, US

(21) Appl. No.: 11/610,028

(22) Filed: Dec. 13, 2006

(51) Int. Cl. A47G 1/16; G09F 7/08; G09F 1/10; A47F 5/08

(52) U.S. Cl. 248/478; 40/768; 211/87.01

(57) ABSTRACT

A system for displaying photographs is disclosed. The system includes one or more horizontal members or bars that are secured to a wall, such as a wall of a house. The horizontal members are preferably immovably secured, as by wall anchors or nails. The horizontal members preferably include a profile, such as a shaped, hollow cross-sectional area, that is configured to mount two or more vertical members. Two or more vertical members or bars are then secured to the horizontal members. The vertical members may be mounted using the profiles, channels, or grooves of the horizontal members. They may be mounted using a tab or a clamp, such as a spring clamp. The vertical members preferably also include continuous, vertical grooves on their sides, for placing photographs into the grooves for display.

### FIELD OF THE INVENTION

This invention generally relates to a system for mounting photographs and other images for display.

### BACKGROUND OF THE INVENTION

The present invention is directed to systems for displaying photographs and similar items in a pleasing manner. The prior art shows several examples of systems for holding or displaying objects, but none has the desired degree of simplicity and reliability that is sought in the present invention. For example, U.S. Pat. Nos. 3,041,762 and 7,100,317 each provide a device for displaying a picture or photograph, but do not provide for a way to display more than a single photograph at a time. In addition, each provides no way to support the display device other than directly onto a horizontal surface, such as a table or a shelf.

Other prior art devices provide for more than a single photograph or object, but do not provide for a display device that is easy to use, i.e., to change the objects, also provide for a way to hold the devices securely. For example, U.S. Pat. No. 5,341,942 discloses a system for displaying compact discs, using a series of vertical and horizontal members. The horizontal members have a horizontal groove for holding compact discs in a loose manner, rather than holding them securely. In addition, this disclosure does not specify how the horizontal members are supported on the vertical members, other than very heavy and awkward-looking support members.

Another prior art invention in this field, U.S. Pat. No. 6,715,620, uses frames to secure and display album covers for phonographic records. The album covers are captured in vertical slots of horizontal slats, the horizontal slats being part of a frame for holding the album covers. The covers must be fully inserted from the side, and thus are not easily removed from the frame. In addition, there is no detail on how the frame is assembled other than that the members are made of solid wood pieces. These frames would thus be heavy and, because of the shape of method of making the slots, would also be difficult to use.

U.S. Design Pat. D405,306 is similar to the above two multiple-object display devices, in the sense that it also depicts a frame or wall grid. The illustrations in the design patent seem to be made from solid objects, such as wood or plastic. It is not obvious how the components are held together, and there are no obvious slots for holding photographs or other objects.

U.S. Pat. No. 6,053,468 discloses a frame support system for holding frames, such as framed art work or similar objects. This system would not enable a user to support photos or art work independently, since each object would still require a frame or other support. In this system, for instance, the frame support system would provide a way to support frames via a wire attached to the rear of the frame. This system would be more elegant than a wall anchor and nail support, but would still require separate frames for each object.

Embodiments of the present invention provide an improved frame support without the disadvantages of the above prior art devices. These and other advantages of the invention, as well as additional inventive features, will be apparent from the description of the invention provided herein.

### BRIEF SUMMARY OF THE INVENTION

One embodiment of the invention is a system for supporting photographs. The system includes at least one horizontal member having a hollow portion, and two or more vertical members having a shaped cross section and configured for support by the at least one horizontal member, wherein the at least one horizontal member is configured for mounting in a primarily horizontal orientation and the vertical members are configured for mounting in a vertical orientation, the vertical members also having a portion for mounting in the hollow portion of one or more of the at least one horizontal member, and the vertical members are configured for supporting photographs.

Another embodiment of the invention is a system for supporting and displaying photographs. The system includes at least one horizontal member having a cross-section in the shape of a channel or groove, and two or more vertical members having a profile and configured for support by the at least one horizontal member, wherein the at least one horizontal member is configured for mounting in a primarily horizontal orientation and the vertical members are configured for mounting in a vertical orientation, the at least one horizontal member configured for continuous horizontal adjustment of the vertical members, the vertical members also having a portion for mounting in the channel or groove of one or more of the at least one horizontal members, the vertical members configured for supporting and displaying objects.

Another embodiment of the invention is a system for supporting and displaying photographs. The system includes two or more horizontal members having a cross-section in the shape of a channel, and two or more vertical members having vertical grooves for supporting and displaying photographs, the vertical members configured for support by the horizontal members by plastic tabs attached to the vertical members and inside the channel, wherein the horizontal members are configured for mounting in a horizontal orientation and the vertical members are configured for mounting in a vertical orientation, the horizontal members configured for continuous horizontal adjustment of a position of the vertical members.

Another embodiment of the invention is a system for supporting photographs. The system includes two or more horizontal members having notches or orifices, and two or more vertical members having a profile and configured for support in the notches or orifices of the horizontal members, wherein the horizontal members are configured for mounting in a horizontal orientation and the vertical members are configured for mounting in a vertical orientation, the vertical members also having a portion for mounting in the notches or orifices of the horizontal members, and the vertical members are configured for supporting photographs.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a first embodiment of the invention;

FIG. 2 is an exploded view of a second embodiment;

FIG. 3 is an exploded view of a third embodiment;

FIG. 4 is an exploded view of a fourth embodiment;

FIG. 5 depicts an additional clamp useful in embodiments of the invention;

FIG. 6 illustrates a photograph and backing useful in the above embodiments;

FIGS. 7-8 are views showing how photographs may be displayed with any of the above embodiments;

FIG. 9 illustrates an additional embodiment;

FIGS. 10a-10d illustrate a swiveling clamp useful in several embodiments; and

FIG. 11 illustrates a swiveling clamp arrangement.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE PRESENTLY PREFERRED EMBODIMENTS OF THE INVENTION

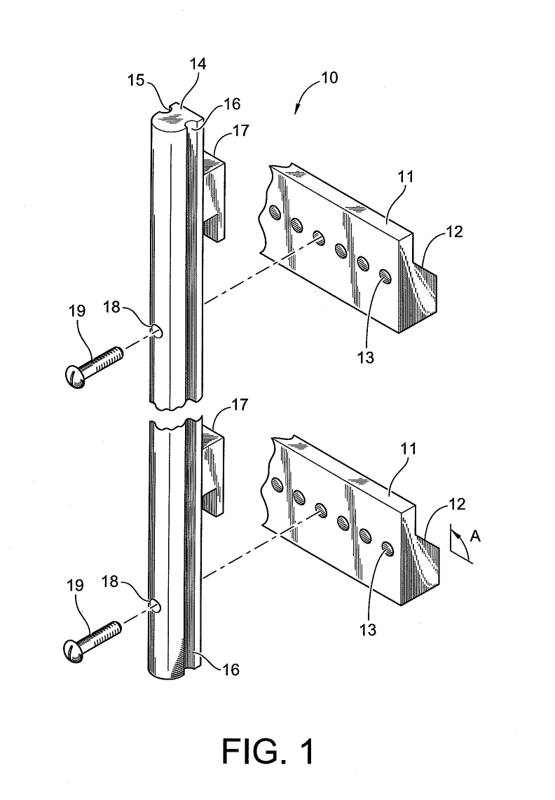

There are many ways to use this invention, a few of which are described below. FIG. 1 illustrates a first embodiment of a system 10 for supporting and displaying photographs. The system includes two or more horizontal members 11, each of which has a continuous horizontal notch 12 and two or more drilled holes 13. It is preferred that two horizontal members 11 are used to support each vertical member 14, as shown. The horizontal members 11 are fastened to a wall (not shown) with anchors, screws, or other fasteners that are inserted through holes 13. The continuous notches 12 of the horizontal members provide a space adjacent the wall for a tab 17 from two or more vertical members 14. The notches may be made at a right angle to the vertical, or may be made at an angle A, such as a 45° degree angle to the horizontal, as shown.

Vertical members 14 preferably include notches 15, 16 on either side. The notches are preferably continuous vertical notches along the length of the vertical member. Because the notches in the horizontal members are continuous, the vertical members may be placed at any point along the length of the horizontal members. That is, the horizontal members are configured so that the placement of the vertical members may be adjusted horizontally as desired, in a continuously variable manner. Using the vertical supports, photos may then be supported on their sides, rather than on the top and bottom of the photos. In addition, the supports may be adjusted, both horizontally and vertically, as desired, for placement of the photos as desired. If desired, the vertical members 14 may also be stabilized by drilling holes 18 and securing the vertical members to the horizontal members 11 with fasteners 19.

Tab 17 may be integrally formed with vertical member 14, or may be formed by assembling tab 17 into vertical member 14. For example, if vertical members 14 are made of wood or plastic, the tab may be machined or molded as part of the vertical member. Alternatively, the tab may be fastened to the vertical member, as by a screw or a nail, or may be snap-fit into the vertical member if plastic parts or other suitable materials are used. In use, two or more horizontal members 11 may be placed horizontally on a wall, separated by a suitable vertical distance. Vertical members 14 are then placed on the display, separated by a suitable horizontal distance, each vertical member supported by at least one, and preferably two or more, horizontal members. The intended use of the system is to support photos, or other objects, that are very light in weight. Thus, in general, the system will weigh much more than the photos or other objects that the system in intended to support and display. The vertical members thus may only need support from a single horizontal member, although the use of two horizontal members is preferred. The horizontal members 11, however, preferably have a plurality of orifices 13 from which to choose two or more for supporting the horizontal members on a wall or other vertical display surface.

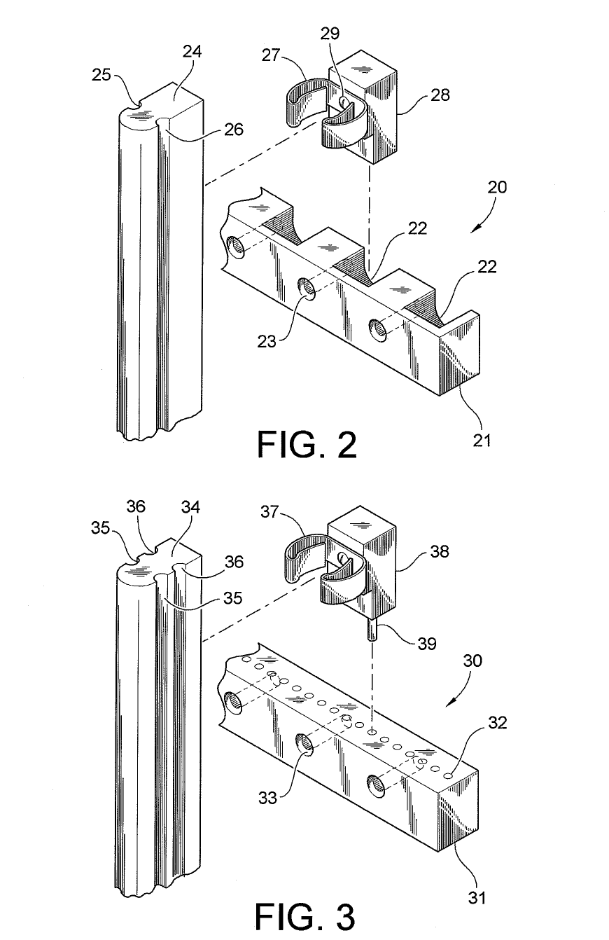

FIG. 2 illustrates a second embodiment of components useful in a display system 20. In this embodiment, horizontal members 21 have discrete notches 22 instead of a continuous notch as in the previous embodiment. The horizontal members 21 also have drilled holes 23 for fastening to a vertical display surface, such as a wall. The vertical members 24 include continuous vertical notches 25, 26. Each vertical member is secured to one or more horizontal members using one or more clamps 27, tabs 28, along with fasteners 29 that secure each clamp 27 to tab 28. Clamp 27 is preferably a flex spring clamp, such as a hose clamp or a spring steel clamp. These clamps are typically made from thin spring steel or flexible plastic. The clamp may then be mounted to the appropriate position on the vertical member 24, and the clamp is secured to the horizontal member 21 by placing tab 28 into the desired notch 22. Alternatively, the tab 28 may fit very tightly into notch 22, and the vertical member may then be joined to clamp 27 at the desired vertical (up and down) position or height. Thus, the tab and clamp may be part of the horizontal member or the vertical member.

In the embodiment of FIG. 2, the horizontal adjustment of the vertical members is limited to the discrete positions of the notches 22. However, if the clamps are secured to the horizontal members, such as by fitting tightly into the chosen notch, then the vertical position (up and down) of the vertical member may be adjusted as desired by a large amount or by an infinitesimal amount. That is, the vertical position of the vertical members is continuously variable, by adjusting their position as held by the clamps, rather than being limited to adjustment of discrete amounts, e.g., the horizontal position of the vertical member.

An exploded view of another embodiment is depicted in FIG. 3. In this embodiment, the supporting system 30 includes horizontal members 31 and vertical members 34. The horizontal members 31 include a first plurality of orifices 32 for supporting vertical members 34 and a second plurality of orifices 33 for attaching horizontal members 31 to a display surface, such as a wall. Vertical members 34 include two forward notches 35 which are preferably continuous vertical notches, for supporting and displaying photographs or other objects. The vertical members also include two additional continuous vertical notches 36 toward the rear of the vertical members. In the preferred method of using this embodiment, each vertical member includes one or more clamps 37 which grasp the vertical member securely using notches 36. Each clamp 37 is fastened or otherwise attached to an attachment member 38 and a tab 39. Tab 39 supports the vertical member 34 when tab 39 is inserted into one of the orifices 32. If the tabs and attachment members are secured to the horizontal members 31, then the vertical position of the vertical member is continuously adjustable through clamp 37, similar to the adjustment described for FIG. 2.

Attachment member 38 may be fastened to clamp 37 with a fastener, such as a screw. Attachment member 38 may be made from plastic or wood, and may include an integral tab 39, as when the two are machined from wood or injection molded from plastic. Clamp 37 is preferably a flex-type spring, such as a constant-force clamp, or may be any other suitable clamp or spring useful for attaching the vertical member to the attachment member 38 and tab 39. As noted, the vertical position of the vertical members is infinitely adjustable using clamp 37. Another embodiment of one such constant-force clamp is disclosed in FIG. 5. Clamp 53 is made from spring steel, or a plastic strip, gathered into two coils, 54, 55, which exert a closing force that holds an object, such as a vertical member, between the coils. Clamp 53 may be secured to a horizontal member or to a tab by a fastener in the backing coil 56. Twin-spool clamps such as these may be made from spring steel coils, available from Sandvik Materials Technology, Scranton, Pa., and known as twin-spool A-motor springs. The clamps may be made from spring wire or other materials available from other manufacturers in other configurations.

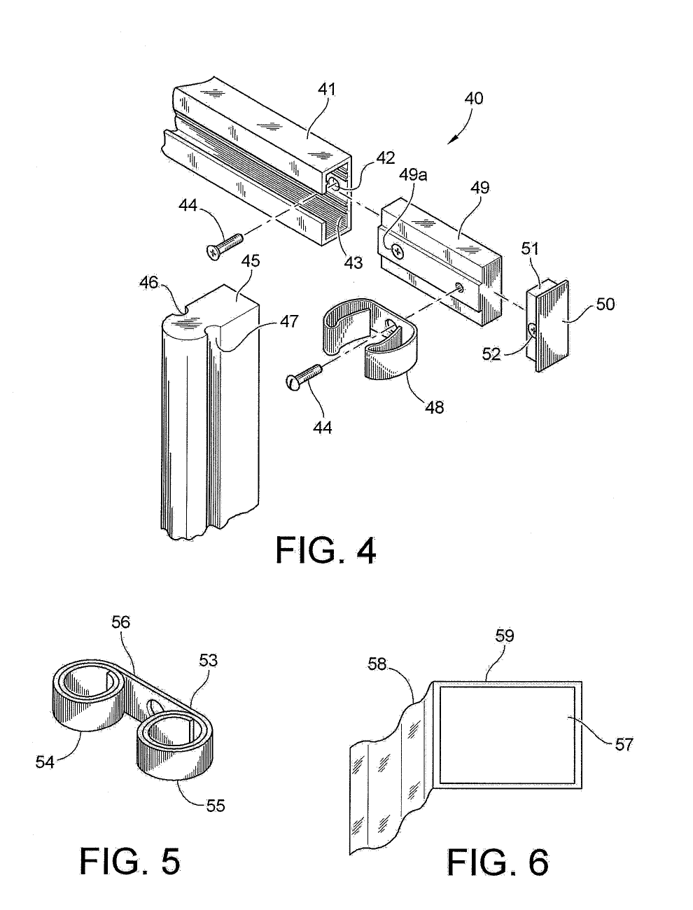

The horizontal members need not be solid, as shown in the above embodiments, but may be made from a hollow type of construction member, such as a channel. FIG. 4 depicts an embodiment in which the display system 40 includes horizontal members made of hollow channels 41, the channels having a cross-section in the general shape of a capital “C.” Other channels may have cross-sections in the general shape of a capital “U” on its side. The web 43 of horizontal member channel 41 has a plurality of holes 42 from which to choose when using fasteners or screws 44 to attach the horizontal members to a wall or other surface. Instead of screws, standard wall anchors may be used.

In this embodiment, the horizontal members add tabs 49 that are held within the hollow portion of the channel. Tab 49 may be secured in place by set screw 49a, or similar locking device, that secures tab 49 to channel 41. Each tab 49 is attached to a clamp 48, using a fastener 44 or other device. The clamp is suitable for securely grasping a single vertical member 45. Vertical member 45 includes two grooves 46, 47, for securing photographs in grooves of adjacent vertical members. There may also be an end cap 50 for each end of the horizontal members. End cap 50 may include an inner tab 51 with an orifice 52 for securing the end cap to the channel 41 or to the wall, as desired. The end cap may prevent scratches or cuts if the channels used as horizontal members have sharp edges or cutting surfaces.

Because the inner portion of channel 41 is hollow, the horizontal position of tab 49 is infinitely adjustable. Since the position of tabs 49 determines the horizontal position of the vertical members 45, the horizontal positions of the vertical members is thus infinitely adjustable. As described previously, the vertical positions of the vertical members is also infinitely adjustable, since the clamps 48 allow easy adjustment of the vertical position of the vertical members. Thus, in this embodiment, the vertical members are easily adjusted in both vertical and horizontal directions, making for easy adjustments of photo displays. This may be important when changing displays and when using photographs of more than one size, such as 4 inches×6 inches, 8 inches by 10 inches, or 5 inches×7 inches.

Embodiments may be used to develop pleasing displays of a multitude of photographs, as shown in FIGS. 6-9. The displays use a multitude of photographs, supported in the grooves of vertical members. Vertical members are in turn supported as shown above by horizontal members, the horizontal members secured to the wall on which the display is desired. Each photo 57 may be displayed as printed. Alternatively, the photograph 57 may be given a backing 59 in order to provide a stiffer and more readily handled photograph. Examples of backings suitable for 5 inches×7 inches or other size photographs include polystyrene that is 0.030 inches thick (30 mil polystyrene) with a clear plastic cover 58. The photos may be mounted using adhesive suitable for photographs, such as Photo Mount Adhesive from the 3M Company, Minneapolis, Minn., U.S.A. This backing has proven useful in mounting photographs on our prototypes. For larger photographs, such as enlargements that are 20 inches by 30 inches, a stiffer backing may be obtained by using a thicker polystyrene, such as 0.060 inches thick (60 mil). Other materials and thicknesses may be used, but backings which are re-usable and which have little shape memory are preferred.

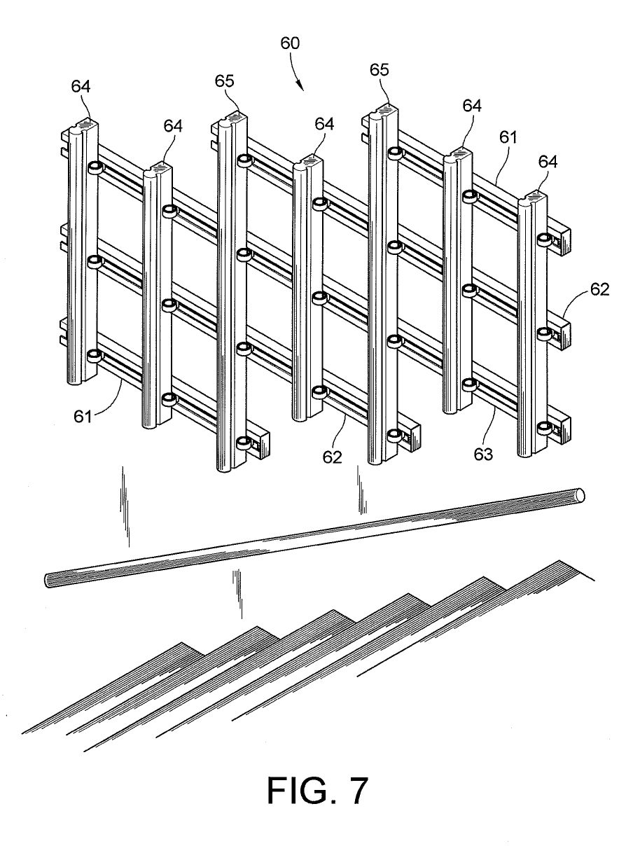

FIG. 7 depicts an embodiment in which the vertical and horizontal members described above may be used to fabricate a photographic display 60 near a staircase. In this embodiment, the display advances upwards and to the right in steps that match those of a standard staircase, about eight inches of rise for every ten inches of run. The display includes two short horizontal members 61, two longer horizontal members 62, and a middle, very long horizontal member 63. These horizontal members support five shorter vertical members 64 and two longer vertical members 65. The clamps and tabs as described above are used to hold the vertical members. One example is a series of photos that are 8 inches high by 10 inches wide. This is only one example of the ways that the above components may be joined to create a pleasing and structurally sound display.

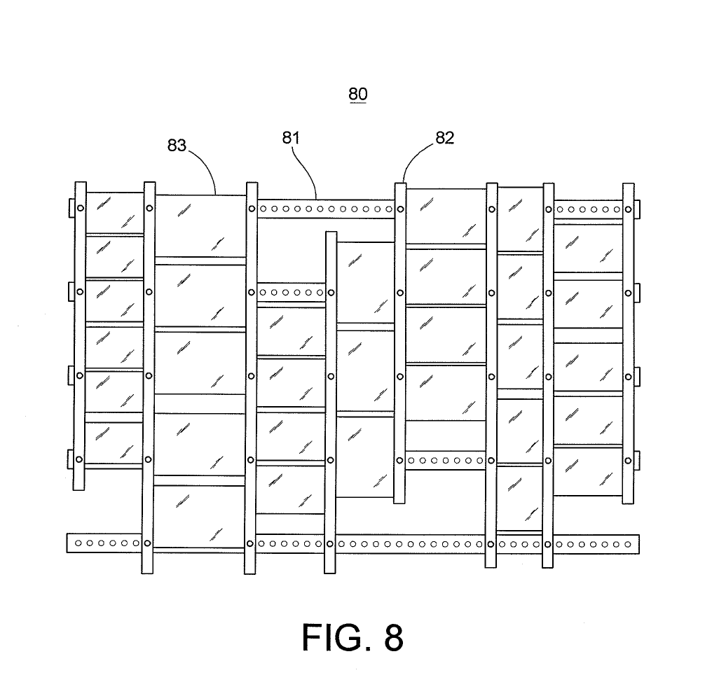

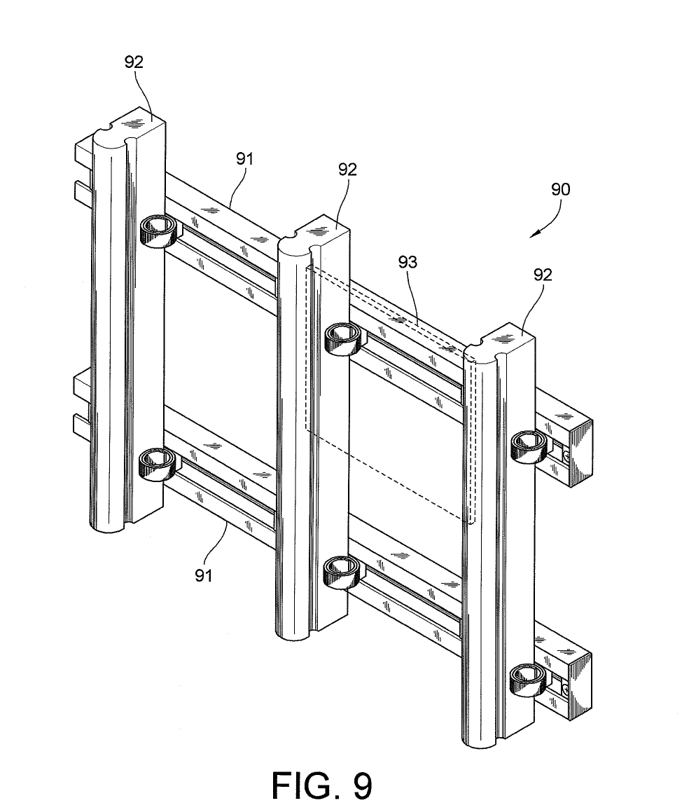

FIGS. 8-9 disclose additional displays using the hardware described above. FIG. 8 uses a more-or-less random distribution, in which display 80 uses a plurality of horizontal members 81 and vertical members 82, to support and display a plurality of photographs 83. In this embodiment, the photographs are displayed in vertical columns with somewhat random placement, with not every column having a complete column of photos and not every row including a complete row of photos. As can be seen in the photo, some of the rearward horizontal members may be seen, and some of the vertical members do not have a complete column of photos, allowing passers-by to see some portions of the horizontal and vertical members.

It is preferred, for obvious reasons, to conceal the presence of the horizontal and vertical members as much as possible. One embodiment of a display 90 in which this is accomplished is disclosed in FIG. 9. Display 90 includes only a single row of horizontal photos 93. The display is made from two horizontal members 91 that support three vertical members 92. The vertical members support photos 93 as described above. With careful placement, the horizontal members 91 may be hidden behind the vertical members 92 and the photos 93, the horizontal members not easily visible. This creates a more elegant display, which is further improved if the photos 93 are placed slightly more closely together than their horizontal length, resulting in a slightly concave configuration (bowed outward) that is more visually pleasing. Another embodiment uses only a single horizontal member 91, with the vertical members as shown, for a single row of photos, although taller vertical members would also allow for more than a single row. In general, the vertical members will be visible, because the vertical members directly support the photos for display, preferably by using vertical notches as discussed above.

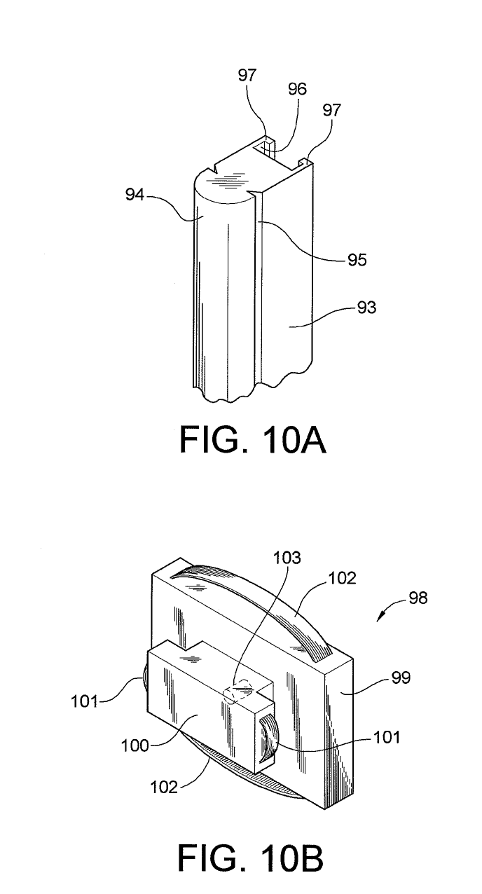

Besides the clamps described above, other clamps may be used to secure the vertical members to the horizontal members. FIG. 10a depicts a cross-section of a vertical member 94 which is adapted for use with a spring clamp having external leaf springs to grip both vertical member 93 and the horizontal members described above, particularly the hollow embodiments, such as a horizontal channel. Vertical member 93 includes a front portion 94 with two vertical notches 95 for holding photos. The rear portion of the vertical member includes a vertical hollow 96 for holding a spring clamp, described below. Rear portions 97 complete the vertical member and help to secure the spring clamp.

A spring clamp 98 is described in three views, FIGS. 10b, 10c, and 10d. The clamp includes two portions, a rear portion 99 for mounting within a hollow horizontal member, and a forward portion 100 for mounting within a hollow vertical member, or a vertical notch or hollow of a vertical member, as shown in FIG. 10a. The rear and forward portions 99, 100 are swivelingly or rotatably joined by a pin 103. The rear portion 99 is held by two transverse horizontal leaf springs 102, which securely hold the spring clamp. The forward portion 100 is held within the vertical member by two transverse vertical leaf springs, which hold the clamp sufficiently securely to also hold the vertical member and the photos mounted in the forward notches of the vertical member. Because the pin allows the rear and forward portions to rotate or swivel with respect to each other, the vertical members may mount to the horizontal members at an orientation other than 90°. The position of this clamp within the horizontal member is continuously adjustable, as is the placement of the clamp with respect to the vertical members.

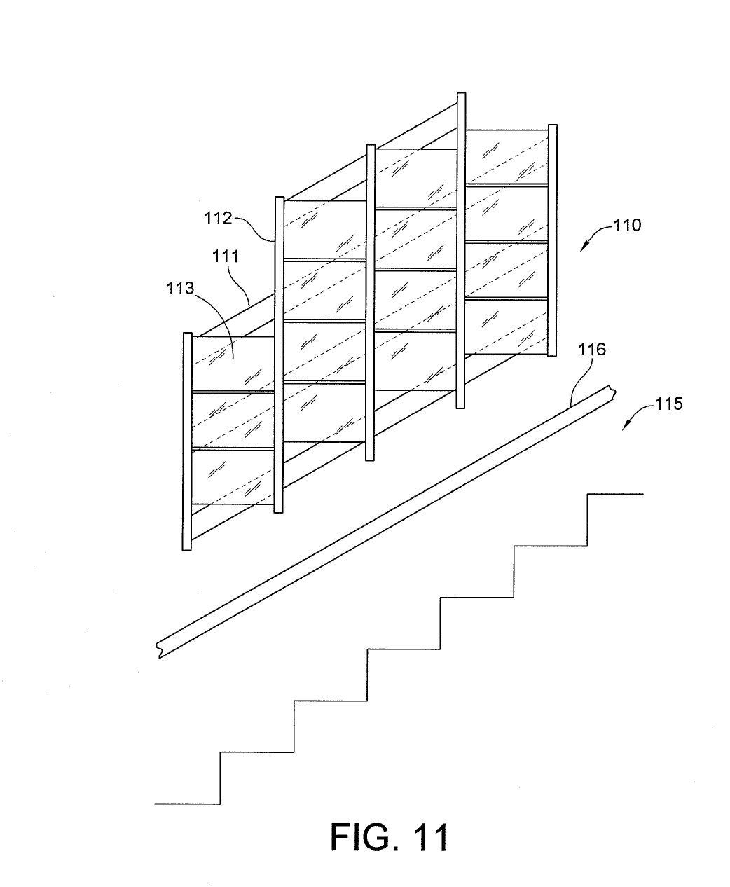

An embodiment which may take advantage of the ability of the clamps to swivel is depicted in FIG. 11. A photo arrangement 110 is made from a plurality of horizontal members 111 and a plurality of vertical members 112. In this arrangement, by a stairs 115, the “horizontal” members are oriented at about 35-40 degrees to the horizontal, which is close to the normal angle of stairs, about 10 inches run for every 8 inches of rise. This creates a pleasing effect with the “horizontal members” 111 roughly parallel to the stairs 115 and stair rail 116. While this orientation of members 111 is not strictly “horizontal,” the orientation is primarily horizontal, in that the members 111 are oriented to the vertical members 112 by an angle of less than 45°. As described above, the vertical and horizontal members are securely joined by swiveling clamps. Other angles are possible, within the limits of the particular clamp selected.

All references, including publications, patent applications, and patents cited herein are hereby incorporated by reference to the same extent as if each reference were individually and specifically indicated to be incorporated by reference and were set forth in its entirety herein. While there are many embodiments, it should be noted that the entire system as described may be turned ninety degrees, with the horizontal members becoming vertical and the vertical members becoming horizontal. The embodiments described herein assume that photographs or other objects will be displayed while being held or supported on their vertical sides. However, the entire system may be turned ninety degrees so that photographs may be supported on their horizontal (top and bottom) sides instead.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for supporting photographs, the system comprising:
at least one horizontal member having a hollow portion; and
two or more vertical members having a shaped cross section and configured for support by the at least one horizontal member,
wherein the at least one horizontal member is configured for mounting in a primarily horizontal orientation and the vertical members are configured for mounting in a vertical orientation, the vertical members also having a portion for mounting in the hollow portion of one or more of the at least one horizontal member, and the vertical members are configured for supporting photographs.

2. The system according to claim 1, wherein the hollow portion of the at least one horizontal member is selected from the group consisting of a notch, a series of notches, a series of orifices, and a channel.

3. The system according to claim 1, wherein a cross section of the vertical members includes a notch on at least one side of the vertical member.

4. The system according to claim 1, wherein the vertical members are configured for support by one of the at least one horizontal member by a tab for mounting in the hollow portion of one of the at least one horizontal member.

5. The system according to claim 1, wherein the vertical members are configured for support by the at least one horizontal member, the vertical members having an integral tab for mounting in the hollow portion of one of the at least one horizontal member.

6. The system according to claim 1, wherein the vertical member is configured for support by one of the at least one horizontal member with a clamp and a tab.

7. The system according to claim 1, wherein the vertical members are secured to the at least one horizontal member by clamps.

8. The system according to claim 1, wherein the vertical members include vertical grooves for supporting photographs.

9. The system according to claim 1, wherein the at least one horizontal member is configured for continuous horizontal adjustment of the vertical members.

10. The system according to claim 1, further comprising at least two spring clamps, each spring clamp comprising two portions rotatably mounted to each other.

11. A system for supporting and displaying photographs, the system comprising:
at least one horizontal member having a cross-section in the shape of a channel or groove; and
two or more vertical members having a profile and configured for support by the at least one horizontal member,
wherein the at least one horizontal member is configured for mounting in a primarily horizontal orientation and the vertical members are configured for mounting in a vertical orientation, the at least one horizontal member configured for continuous horizontal adjustment of the vertical members, the vertical members also having a portion for mounting in the channel or groove of one or more of the at least one horizontal member, the vertical members configured for supporting and displaying objects.

12. The system of claim 11, wherein the at least one horizontal member has a cross-sectional shape of a C or a U.

13. The system of claim 11, wherein the vertical members further comprise a tab for support by the at least one horizontal member.

14. The system of claim 11, further comprising at least two clamps for supporting two or more vertical members by the at least one horizontal member.

15. The system of claim 11, wherein the vertical members comprise at least one continuous vertical groove.

16. The system of claim 11, further comprising at least one photograph and a backing applied to the photograph.

17. A system for supporting and displaying photographs, the system comprising:
two or more horizontal members having a cross-section in the shape of a channel; and
two or more vertical members having vertical grooves for supporting and displaying photographs, the vertical members configured for support by the horizontal members by plastic tabs attached to the vertical members and inside the channel;
wherein the horizontal members are configured for mounting in a horizontal orientation and the vertical members are configured for mounting in a vertical orientation, the horizontal members configured for continuous horizontal adjustment of a position of the vertical members.

18. The system of claim 17, wherein the horizontal members have a cross-sectional shape of a C or a U.

19. The system of claim 17, wherein the two or more horizontal members further comprise at least two clamps for supporting two or more vertical members.

20. The system of claim 17, wherein the two or more horizontal members further comprise at least two spring clamps for supporting two or more vertical members.

21. The system of claim 17, wherein the vertical members comprise at least one continuous vertical groove.

22. A system for supporting photographs, the system comprising:
two or more horizontal members having notches or orifices; and
two or more vertical members having a profile and configured for support in the notches or orifices of the horizontal members,
wherein the horizontal members are configured for mounting in a horizontal orientation and the vertical members are configured for mounting in a vertical orientation, the vertical members also having a portion for mounting in the notches or orifices of the horizontal members, and the vertical members are configured for supporting photographs.

23. The system according to claim 22, wherein the vertical members are configured for support by the horizontal members by a tab for mounting in the notches or orifice of one or more of the horizontal members.

24. The system according to claim 22, wherein the vertical members are configured for support by the horizontal members by an integral tab for mounting in one of the notches or orifices of one or more of the horizontal members.

25. The system according to claim 22, wherein the vertical members are configured for support by one or more of the horizontal members with a clamp and a tab mounted on the vertical members.

26. The system according to claim 22, wherein the vertical members are secured to the horizontal members by clamps or springs that are secured to the horizontal members.

27. The system according to claim 22, wherein the vertical members are secured to the horizontal members by clamps or springs that are secured to the vertical members or to the horizontal members.

28. The system according to claim 22, further comprising at least one spring clamp, the spring clamp including a forward portion rotatably mounted to a rear portion, and at least one of the forward and rear portions secured to a horizontal member or a vertical member by leaf springs.
